(19) United States
(12) Patent Application Publication
(10) Pub. No.: US 2024/0299887 A1
(43) Pub. Date: Sep. 12, 2024

(54) THIN-FILM COMPOSITE MEMBRANES HAVING IMPROVED ADHESION BETWEEN LAYERS AND USES THEREOF

(71) Applicant: Compact Membrane Systems, Inc., Newport, DE (US)

(72) Inventors: Sudipto MAJUMDAR, Newark, DE (US); Robert D. LOUSENBERG, Wilmington, DE (US); Kenneth E. LOPRETE, Cherry Hill, NJ (US); Ning SHANGGUAN, Cherry Hill, NJ (US); Irene GONCHAROVSKY, Cherry Hill, NJ (US); Jacob A. WARGO, Wilmington, DE (US)

(21) Appl. No.: 18/578,397

(22) PCT Filed: Jul. 7, 2022
(86) PCT No.: PCT/US2022/036284

§ 371 Date: Jan. 11, 2024

Related U.S. Application Data
(60) Provisional application No. 63/220,780, filed on Jul. 12, 2021.

(51) Int. Cl. B01D 69/12; B01D 53/22; B01D 63/10; B01D 69/02; B01D 71/34; B01D 71/36; B01D 71/44; B01D 71/70

(52) U.S. Cl. CPC B01D 69/12; B01D 53/228; B01D 63/10; B01D 69/02; B01D 71/34; B01D 71/36; B01D 71/44; B01D 71/70; B01D 2256/22; B01D 2256/24; B01D 2257/102; B01D 2257/7022; B01D 2323/2181; B01D 2325/04; B01D 2325/14; B01D 2325/20; B01D 2325/32

(57) ABSTRACT

In an aspect, provided herein is an improved thin-film composite membrane and gas-separation processes using the composite membrane. The composite membrane incorporates a gutter layer from a polymer material selected from a substituted polyacetylene, an addition-polymerized and substituted polynorbornene, or an addition-polymerized and substituted polytricyclononene. The gutter layer provides improved adhesion with a gas-separation layer incorporating a fluorinated ionomer.

### CROSS REFERENCE TO RELATED APPLICATIONS

This application claims the benefit of priority to U.S. Provisional Patent Application No. 63/220,780, filed on Jul. 12, 2021.

### GOVERNMENT RIGHTS

This invention was made with government support under DE-SC0021881 awarded by the Department of Energy. The government has certain rights in the invention.

### BACKGROUND

Membranes can be used for separation of gas mixtures that are produced in industrial processes, such as energy production. These separations can include separation of alkenes from alkanes such as propylene from propane in hydrocarbon refinery operations, separation of carbon dioxide from hydrocarbons such as methane (i.e., biogas), or separation of carbon dioxide from nitrogen in effluent streams from the combustion of hydrocarbons (i.e., flue gases).

Useful membranes can include composite membranes that have a thin gas-separation layer contacted to a high-diffusion rate layer (gutter layer) for increased permeance, and a porous-layer support for overall strength and durability. However, there is an unmet need for composite membranes having gas separation layers that remain strongly adhered to the gutter layer. For example, weakly adhered layers may be prone to delamination and damage from a fabrication process for making large-area modules for commercial applications. A delaminated or damaged gas-separation layer can have reduced performance with lower gas-separation selectivity.

### SUMMARY

In an aspect, provided herein is a thin-film composite membrane having improved adhesion between a gutter layer and a fluorinated ionomer in a gas-separation layer. The membrane can have greater permeability compared to a comparable membrane without a gutter layer. The thin-film composite membrane comprises a porous-layer support; a gas-separation layer comprising a fluorinated ionomer; and a gutter layer comprising a polymer material having a glass transition temperature greater than 100° C. The polymer material is selected from a substituted polyacetylene comprising a repeating unit structure (1), an addition-polymerized and substituted polynorbornene comprising a repeating unit structure (II), or an addition-polymerized and substituted polytricyclononene comprising a repeating unit structure (III) as follows:

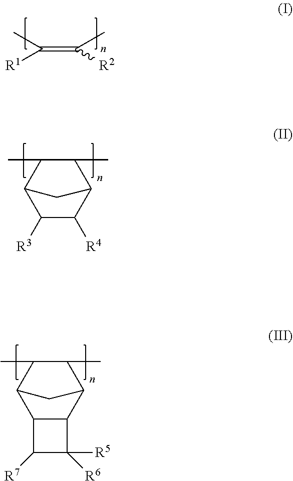

wherein n is a number that defines the degree of polymerization; R¹ comprises an alkyl or an aromatic group; R² comprises an aromatic group or a silyl group; R³ is H or comprises an alkyl group, a silyl group, or an alkoxy-silyl group; R⁴ comprises a silyl group, or an alkoxy-silyl group; R⁵ is H or comprises a silyl group or an alkoxy-silyl group; R⁶ comprises a silyl group or an alkoxy-silyl group; R⁷ is H, or if R⁵ is H, then R⁷ comprises a silyl group or an alkoxy-silyl group.

In some embodiments, the substituted polyacetylene can be poly(1-trimethylsilyl propyne), the addition polymerized and substituted polynorbornene can be poly(5-trimethylsilyl norborn-2-ene), and the addition-polymerized and substituted polytricyclononene can be poly(3,3-bis(trimethylsilyl)tricyclonon-7-ene). The polymer material can have an intrinsic permeability to carbon dioxide that is greater than 2800 Barrer (8.04×10⁻¹³ mol m/(m² s Pa)) and the gutter layer thickness can be between 0.1 μm and 1 μm. The porous-layer support for the gutter layer can comprise polyvinylidine fluoride, expanded polytetrafluoroethylene, polyacrylonitrile, polysulfone, or polyethersulfone.

In some embodiments, the fluorinated ionomer can comprise polymerized repeating units of tetrafluoroethylene and a perfluorovinyl ether monomer comprising a pendant sulfonic acid or sulfonate functionality. The sulfonate functionality can be selected from silver sulfonate, ammonium sulfonate, alkyl ammonium sulfonate, lithium sulfonate, or sodium sulfonate. The gas separation layer thickness can be between 0.02 μm and 0.5 μm.

In another aspect, provided herein is a spiral-would membrane module comprising the thin-film composite membrane as described herein.

In another aspect, provided herein is a process for separating an alkene from a first gas mixture, the process comprising providing a thin-film composite membrane as described herein having silver sulfonate functionality, a feed side, and a permeate side; exposing the feed side to the first gas mixture that is flowing; providing a driving force across the thin-film composite membrane; and producing a second gas mixture on the permeate side that has a higher concentration of alkene than the concentration of alkene in the first gas mixture. In some embodiments the first gas mixture comprises propylene and propane and further comprises water vapor.

In another aspect, provided herein is a process for separating carbon dioxide from a first gas mixture, the process comprising: providing a thin-film composite membrane as described herein, having a feed side and a permeate side; exposing the feed side to the first gas mixture that is flowing; providing a driving force across the thin-film composite membrane; and producing a second gas mixture on the permeate side that has a higher concentration of carbon dioxide than the concentration of carbon dioxide in the first gas mixture. In some embodiments, the first gas mixture further comprises nitrogen, methane, or water vapor. Providing a driving force can comprise applying a vacuum to the permeate side.

This summary of the invention introduced some of the embodiments of the invention and is not intended to be limiting. Additional embodiments including variations and alternative configurations of the invention are further described in the detailed description of the invention and the examples. Certain exemplary embodiments of the present invention are described herein are only for purposes of illustrating the present invention and should not be interpreted as limiting the scope of the invention. Other embodiments of the invention, and certain modifications, combinations, and improvements of the described embodiments, will occur to those skilled in the art and all such alternate embodiments, combinations, modifications, improvements are within the scope of the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. In addition, use of “a” or “an” are employed to describe elements and components described herein. This is done merely for convenience and for a general sense of the scope of the invention. This description should be read to include one or at least one; the singular also includes the plural unless it is obvious that it is meant otherwise. Certain additional terms are also used and some of them are further defined within the following detailed description of the invention.

### DETAILED DESCRIPTION

A gas-separation layer for a composite membrane can be fabricated from a fluorinated ionomer comprising sulfonate or sulfonic acid functionality such as disclosed in U.S. Pat. Nos. 5,191,151 and 10,639,591. A high-diffusion rate layer, which is also known as a gutter layer in the field of membrane technology, can provide overall greater permeability and can be situated (layered) between the gas-separation layer and a porous-layer support, for overall greater strength and durability. A composite membrane having a gas-separation layer from a fluorinated ionomer and a gutter layer are described in U.S. Pat. No. 10,399,044 and US Patent Publication No. 2021/0016231. Therein, the gutter layer was prepared by solution casting a fluorinated polymer material, such as Teflon® AF 2400, which was pre-dissolved in a fluorinated solvent, onto the porous-layer support. The gas-separation layer was subsequently fabricated by coating (i.e., solution casting) the fluorinated ionomer from a non-fluorinated solvent on top of the gutter layer.

Fluorinated ionomers are hydrophilic and can absorb and permeate liquid water whereas a gutter layer, such as from Teflon® AF 2400, is also fluorinated, hydrophobic, and repels liquid water but can permeate water vapor. While both materials may be fluorinated, this like vs like nature may be insufficient for good layer adhesion and operational lifetime in a humidified environment. A weakly adhered gas-separation layer from a fluorinated ionomer having silver sulfonate functionality can separate from the gutter layer, such as by pulling apart with adhesive tape, and may be prone to delamination and damage from a fabrication process into large-area modules for commercial applications. A delaminated or damaged gas-separation layer can have reduced performance with lower gas-separation selectivity. Therefore, a thin-film composite membrane having improved adhesion between a gutter layer and the fluorinated ionomer in a gas-separation layer with overall greater permeability for the composite membrane versus a comparable composite membrane without a gutter layer is desirable.

In contrast, provided herein is a thin-film composite membrane that has surprisingly improved adhesion between a fluorinated ionomer in a gas-separation layer and a gutter layer comprising a polymer material, which is chemically dissimilar, non-fluorinated, and hydrophobic. The gas-separation layer is laminated to the gutter layer, which is laminated to a porous-layer support. In some instances, the gas-separation layer and the gutter layer are not separated (i.e., peeled apart) using painter's masking tape, unlike a composite membrane having a gutter layer made from Teflon® AF 2400. Herein, the polymer material for incorporation in the gutter layer is selected from a substituted polyacetylene, an addition-polymerized and substituted polynorbornene, or an addition-polymerized and substituted polytricyclononene.

The substituted polyacetylene can include poly(1-trimethylsilyl propyne) (PTMSP), the addition-polymerized and substituted polynorbornene can include poly(5-trimethylsilyl norborn-2-ene) (PTMSN), or the addition-polymerized and substituted polytricyclononene can include poly(3,3-bis(trimethylsilyl)-tricyclonon-7-ene) (PTCNSi2g). Structures for these specific polymer materials are shown in (1), (2), and (3), respectively. The improved adhesion between the gas-separation layer and the gutter layer enables fabrication of the thin-film composite membrane into large-area modules with fewer defects. In some embodiments, the thin-film composite membrane is useful for separation of alkenes from alkanes or separation of alkenes from other gases such as nitrogen. In some embodiments, the thin-film composite membrane may be used for separation of carbon dioxide from gases such as nitrogen, an alkane, or an alkene.

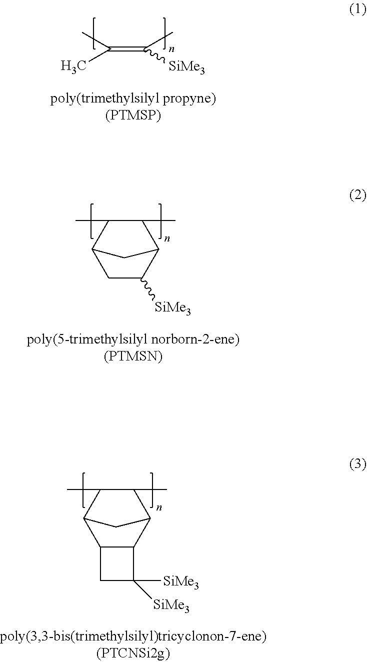

Substituted polyacetylenes, addition-polymerized and substituted polynorbornenes, or addition-polymerized and substituted polytricyclononenes can have high intrinsic gas permeability but low to moderate gas-separation selectivity. Herein, a gutter layer incorporating the polymer material in combination with a gas-separation layer incorporating the fluorinated ionomer can have equivalent carbon dioxide over nitrogen gas-separation selectivity for the thin-film composite membrane with respect to a composite membrane having the gas-separation layer incorporating the fluorinated ionomer directly on the porous-layer support. For alkene separation from alkanes, the thin-film composite membrane can have increased gas-separation selectivity of at least 50%. Equivalent or increased gas-separation selectivity is unexpected since it may be generally understood in the field of membrane technology that gas-separation selectivity was not additive and a gutter layer could increase overall permeance but with a likely cost of reduced gas-separation selectivity. Unlike Teflon® AF 2400, each of PTMSP, PTMSN, and PTCNSi2g are soluble in organic solvents such as toluene. This solubility avoids use of fluorinated solvents, which can simplify manufacturing, avoid much stricter requirements for solvent recovery, and eliminate any potential for release of fluorinated solvent vapor, which can be a potent greenhouse gas.

The polymer materials are substituted in that they incorporate functionality in their repeating unit structure. For example, PTMSP, PTMSN, or PTCNSi2g are silyl-substituted polymer materials that contain trimethylsilyl groups within their repeating unit structure. The silyl-substitution may help with adhesion to the fluorinated ionomer in the gas-separation layer. PTMSP, PTMSN, and PTCNSi2g are also glassy polymer materials having a glass transition temperature greater than 300 Celsius. A glass transition temperature that is greater than an anticipated 100 Celsius maximum operating temperature for the thin-film composite membrane may help to stabilize the interface between the gas-separation layer and the gutter layer and help to retain or possibly enhance gas-separation selectivity with respect to a comparable membrane with a gas-separation layer directly on the porous-layer support.

A substituted polynorbornene or substituted polytricyclononene is addition polymerized. Unlike other possible polymerization techniques such as ring opening metathesis or radical polymerization, the fused ring structure with monomer polymerization to said addition-polymerized polymer materials remains intact and unrearranged. The fused ring structure is therefore bulkier from addition polymerization, resulting in high gas permeability. For example, the reported intrinsic permeabilities of PTMSN and PTCNSi2g, for carbon dioxide are approximately 5,300 and 19,900 Barrer, respectively. PTMSP has an initial carbon dioxide permeability of 34,000 Barrer and its synthesis may also be viewed as an addition polymerization. However, PTMSP does not contain a fused ring structure and its high permeability is due instead to a high free volume from inefficient chain packing of a rigid (vs. bulky) backbone structure. PTMSN, PTCNSi2g, and PTMSP are preferred polymer materials having a permeability greater than the reported 2800 Barrer (8.04×10⁻¹³ mol m/(m² s Pa)) for Teflon® AF 2400.

Other substituted polyacetylenes, other addition-polymerized and substituted polynorbornenes, and other addition-polymerized and substituted polytricyclononenes may have glass transition temperatures of at least 100 Celsius, may have an intrinsic permeability to carbon dioxide that is greater than 2800 Barrer, and may be suitable for incorporation in the gutter layer. General structures for a polymer material having silyl substitution, alkoxy-silyl substitution, or aromatic substitution, in addition to alkyl groups, are shown below. The substituted polyacetylene comprises a repeating unit structure (1), the addition-polymerized and substituted polynorbornene comprises a repeating unit structure (II), and the addition-polymerized and substituted polytricyclononene comprises a repeating unit structure (III). The polymer material may be a homopolymer or a copolymer where n is a number that defines the degree of polymerization; R¹ comprises an alkyl or an aromatic group; R² comprises an aromatic group or a silyl group; R³ is H or comprises an alkyl group, a silyl group, or an alkoxy-silyl group; R⁴ comprises a silyl group, or an alkoxy-silyl group; R⁵ is H or comprises a silyl group or an alkoxy-silyl group; R⁶ comprises a silyl group or an alkoxy-silyl group; R⁷ is H, or if R⁵ is H, then R⁷ comprises a silyl group or an alkoxy-silyl group.

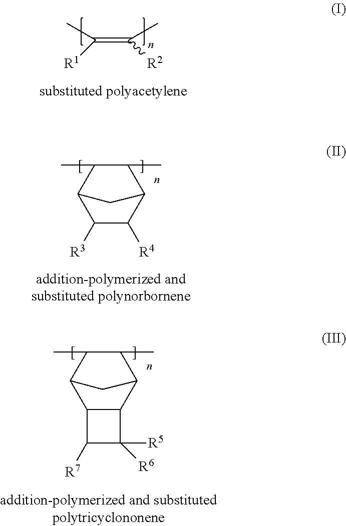

Other substituted polyacetylenes may include certain indan-containing poly(diphenylacetylene) derivatives that were disclosed by Hu et al. in “Synthesis and Properties of Indan-Based Polyacetylenes That Feature the Highest Gas Permeability among All the Existing Polymers” Macromolecules 2008, 41, 8525-8532. Other addition-polymerized substituted polynorbornenes may include alkoxysilyl-substituted polynorbornenes such as disclosed by Maroon et al. in “Addition-type alkoxysilyl-substituted polynorbornenes for post-combustion carbon dioxide separations” Journal of Membrane Science, 595, February 2020, 117532.

PTMSP is commercially available from Gelest (Morrisville, PA) and is soluble in organic solvents that include toluene, cyclohexane, heptane, and chloroform. PTMSN may be synthesized by addition polymerization of 5-trimethylsilyl-2-norbornene as disclosed by Finkelshtein et al. in “Addition-Type Polynorbornenes with Si(CH₃)₃ Side Groups: Synthesis, Gas Permeability, and Free Volume” Macromolecules 2006, 39, 7022-7029. PTMSN is soluble in organic solvents that include toluene and chloroform. PTCNSi2g may be synthesize by addition polymerization of 3,3-bis(trimethylsilyl)tricyclonon-7-ene as disclosed by Gringolts et al. in Russian Patent 2,410,397 or by Chapala et al. in “A Novel, Highly Gas-Permeable Polymer Representing a New Class of Silicon-Containing Polynorbornenes as Efficient Membrane Materials” Macromolecules 2015, 48, 8055-8061. PTCNSi2g is soluble in organic solvents that include toluene and chloroform.

A supported film that will subsequently become the gutter layer may be prepared by coating (i.e., solution casting) of a dilute solution of the polymer material onto the surface of a porous-layer support. The porous-layer support may be in the form of a flat sheet, hollow fiber, or other tube-like and porous structure. For a hollow fiber or other tube-like and porous structure, the dilute solution of the polymer material may be cast on the outer surface (shell) or the inner surface (lumen). A dilute solution of PTMSP, PTMSN, or PTCNSi2g can be prepared in an organic solvent at concentrations that are less than 2%, or between 0.1% and 1%. Acceptable coating methods include but are not limited to ring casting, dip-coating, spin-coating, slot-die coating, roll coating, Mayer rod coating, and injection coating. The organic solvent can be evaporated to form the supported film of the polymer material that will subsequently become the gutter layer. Residual or trace organic solvent remaining in the supported film should not interfere with subsequent fabrication steps.

The supported film that will subsequently become the gutter layer is thin and can be between 0.05 μm to 5-μm, or between 0.1 μm to 1 μm. Permeance, which is pressure normalized flux, is typically reported as a gas permeance unit (GPU) coefficient that has units of GPU×10⁶×cm³(STP)/(cm² s cmHg). Permeability is permeance normalized for thickness and is typically reported in Barrer, in which the Barrer permeability coefficient has units of p_{Barrer}×¹⁰10×cm³(STP)/(cm s cmHg). Together, the supported film and porous-layer support can have a helium or carbon dioxide permeance of at least 5000 GPU, or greater than 10,000 GPU, when measured at 25° C.

The gas-separation layer in the thin-film composite membrane comprises a fluorinated ionomer. A fluorinated ionomer is a fluorinated copolymer that has a fluorinated backbone and covalently bound pendant groups that comprise ionic functionality such as sulfonic acid, sulfonate, carboxylic acid, carboxylate, phosphate, or phosphonium. Fluorinated ionomers comprising sulfonic acid or sulfonate functionality may be more preferred. Certain counter ions (cations) to the sulfonate functionality can impart high water permeation to the fluorinated ionomer. Suitable cations include alkyl ammonium, ammonium, silver, lithium, or a sodium cation. Sulfonate functionality wherein the cation is silver can be used for a practical separation of alkenes from alkanes. The equivalent weight of the fluorinated ionomer is the weight of fluorinated ionomer containing one mole of sulfonate or sulfonic acid functionality. The equivalent weight (EW) can be less than 5000 grams per mole, less than 2000, or between 500 and 800-g/mole. Suitable fluorinated ionomers can include those comprising polymerized repeating units from tetrafluoroethylene and a perfluorovinyl ether monomer, having a pendant sulfonate or sulfonic acid functionality, such as for example Nafion® (Chemours, Wilmington DE), and Aquivion® (Solvay, Houston TX). Aquivion® has a lower equivalent weight than Nafion®.

The gas-separation layer may be fabricated by coating (i.e., solution casting) a dilute solution of the fluorinated ionomer. The dilute solution can be prepared at concentrations that are less than 5% (w/w), less than 2%, or between 0.1% and 2%. The dilute solution can be prepared by mixing a pre-formed, concentrated, and commercially available solution of the fluorinated ionomer with a solvent that is miscible and non-fluorinated. The solvent may be the same or different from the solvent in the pre-formed solution thus forming a solvent mixture. Acceptable dilute solution coating methods include ring casting, dip-coating, spin-coating, slot-die coating, roll coating, and Mayer rod coating. The dilute solution can be coated onto the surface of the film that will become the gutter layer, which can be already on the porous-layer support. The solvent or solvent mixture can be removed such as by evaporation. The solvent or solvent mixture can evaporate to form the to form the “dry” gas-separation layer in a timely manner. The gas-separation layer thickness has a significant influence on permeance of the thin-film composite membrane and is therefore thin with a thickness of 0.01 μm to 5 μm, or between 0.02 μm to 0.5 μm.

The porous-layer support can reinforce the gutter layer and the gas-separation layer that are thin and helps to strengthen the composite such that the thin-film composite membrane may be fabricated into complex geometries that include spiral-wound or hollow-fiber membrane modules. The porous-layer support may be in the form of a flat sheet, hollow fiber, or other tube-like and porous structure. Suitable materials for a porous-layer support include but are not limited to polyvinylidine fluoride, expanded polytetrafluoroethylene, polyacrylonitrile, polysulfone, and polyethersulfone. The porous-layer support may also comprise a porous and even stronger backing material such as a non-woven polyester or polypropylene sheet. Inorganic substrates such as porous silica or alumina sheets or tubes may also be suitable materials for a porous-layer support. The porous-layer support can have a helium or carbon dioxide permeance that is higher than the gutter layer, such as at least 2 times higher, or at least 5 times higher. Permeate gases can flow relatively unobstructed through the porous-layer support having a porosity that is at least 40%. The average pore size can be less 0.1-μm or between 0.01 and 0.03-μm, corresponding to molecular weight cut-offs of approximately 50,000 to 200,000 Daltons, respectively.

The thin-film composite membrane may be subjected to a thermal treatment step and “annealed” to improve mechanical durability and longer-term performance stability. The fluorinated ionomer in the gas-separation layer can be annealed by heating the thin-film composite membrane to near or above the glass transition temperature of the fluorinated ionomer. The exact glass transition temperature will be dependent on the composition of the fluorinated ionomer. Generally, the annealing temperature for the fluorinated ionomer is between 50 and 200° C., and between 75 and 150° C. in some instances. The thin-film composite membrane can be heated for 0.1 to 10 minutes, or for 1 to 5 minutes. An appropriate annealing temperature and time should not degrade the other components of the improved thin-film composite membrane.

The fluorinated ionomer comprising sulfonic acid or sulfonate functionality other than silver sulfonate functionality in the gas-separation layer is initially inactive for separation of alkenes from alkanes. That is, the thin-film composite membrane is not significantly perm-selective (selectivity 55) and the alkene permeance is low (<25-GPU). The thin-film composite membrane may be activated by exchange of protons or other cations (counter ions) for silver in the gas-separation layer. For example, the exchange may be carried out by contacting the exposed surface of the gas-separation layer with a solution comprising water and a soluble and ionizable silver compound such as silver nitrate. A sufficient level of exchange can quickly occur for a thin (≤2 μm) gas-separation layer as evidenced by a high permeance (>100-GPU) and selectivity (>25) for propylene over propane after less than 1 minute of contact with aqueous silver nitrate at ambient (˜23° C.) temperature.

The thin-film composite membrane has improved adhesion between the fluorinated ionomer in the gas-separation layer and the polymer material in the gutter layer with respect to a comparative composite membrane having a gutter layer from, Teflon® AF 2400. The improved adhesion is evident from a peel test using painter's masking tape to separate the gas-separation layer from the underlying gutter layer and wherein the fluorinated ionomer comprises sulfonate functionality such as silver sulfonate, lithium sulfonate, or sodium sulfonate. The painter's masking tape, such as manufactured by 3M (St. Paul, MN), is applied to the surface of a circular sample of a thin-film composite membrane with one end near the center and the other end extended past the edge. The tape is then peeled back from the edge to the center of the sample. The gas-separation layer remained attached to the gutter layer incorporating the polymer material. The gas-separation layer remained adhered to the tape and was peeled away in a comparative test with a comparative composite membrane having a gutter layer incorporating Teflon® AF 2400. Additionally, the sulfonic acid functionality is inherently sticky, strongly adheres to the painter's masking tape, and was not a good indicator of improved adhesion.

The thin-film composite membrane, wherein the counter ion to the fluorinated ionomer is silver, can be useful for the separation of an alkene from an alkane, such as propylene from propane, or separation of an alkene from nitrogen. In some embodiments the thin-film composite membrane may be useful for the separation of carbon dioxide from nitrogen or separation of carbon dioxide from an alkane such as methane. In embodiments where the counter ion is not silver, the thin-film composite membrane may be useful for separation of carbon dioxide from an alkene such as ethene. In a separation process, the thin-film composite membrane is exposed to a flowing gaseous feed-mixture comprising an alkene or carbon dioxide. A “driving force” is provided across the thin-film composite membrane in which the partial pressure of the alkene or carbon dioxide on the feed-side is higher than on the permeate-side of the thin-film composite membrane. The driving force may include applying a vacuum on the permeate-side and may be preferred, due to lower energy consumption, for separation of carbon dioxide from nitrogen in flue gas in electrical generation plants powered by fossil fuels. Gas separation of the alkene or carbon dioxide from the gaseous feed-mixture occurs through the membrane producing a permeate mixture at the membrane permeate-side having a higher concentration of alkene or carbon dioxide than the feed-mixture. The performance of the thin-film composite membrane may be enhanced by having water vapor in the feed mixture and optionally in a sweep gas comprising water vapor at the permeate-side, which may also function to increase the driving force by reducing the alkene or carbon dioxide concentration.

Spiral-wound modules are highly useful for large-scale membrane separations and are an efficient means to assemble large-area flat sheets of the thin-film composite membrane into a compact volume. Spiral-wound module design and construction are well documented in the literature. As generally described, a flat-sheet membrane is folded into a rectangular and slightly asymmetric membrane leaf with the feed side facing outward. The membrane is glued along three sides into a pocket shape with a plastic mesh spacer inside for permeate gas flow. The partly exposed spacer in the asymmetric pocket is sealed (glued) along its edges to a perforated core tube, and then the leaf or multiple leaves, with additional interleafed mesh spacers for feed flow, are wound around the core tube. The outside of the wound module is wrapped with adhesive tape to hold the module components in place.

A spiral-wound module may be configured within a pressure vessel for gas separation. A pressurized feed-gas flow is passed through the open mesh channels of the feed spacers parallel to the long axis of the spiral-wound module and certain components permeate the thin-film composite membrane. The permeated components flow through the open mesh channels of the permeate spacers within a spiral leaf, perpendicular to the long axis and feed flow. The permeated components exit the permeate spacers and are collected in the core tube. Other spiral-wound module designs may be constructed in a similar manner that will allow for a sweep gas or fluid to circulate through the permeate side of the membrane leaf in addition to the core tube. This may be achieved by adding flow-directing elements to the core tube and within the permeate spacers of the pocket-shaped leaf.

### EXAMPLES

### Example 1

Fabrication of a PTMSP gutter layer or Teflon® AF 2400 gutter layer on a porous-layer support. Poly(trimethylsilyl propyne) (PTMSP) was dissolved to 0.5% (w/w) in heptane and filtered through 1 μm glass microfiber. Teflon® AF 2400 was dissolved to 0.5% (w/w) in Opteon® SF10 and filtered through 1 μm glass microfiber. The solutions were then separately cast, using a vertical roll coater, on a 100 cm×200 cm porous-layer support comprising polyvinylidine fluoride (PVDF) ultra-filtration membrane, having a molecular weight cut-off of 100,000 Daltons, on a non-woven polyester backing (Synder, Filtration, Vacaville CA). The solvents were evaporated at ambient room temperature under a dry nitrogen atmosphere to form the supported films that will become the gutter layers. An apparent laminar thickness for the PTMSP supported film was gravimetrically estimated at 0.80 μm using the applied solution mass, concentration, porous-layer support area, and a PTMSP density of 0.77-g/mL. An apparent laminar thickness for the Teflon® AF 2400 supported film control was similarly estimated at 0.25 μm using a Teflon® AF 2400 density of 1.67-g/mL. A 47-mm diameter sample from each supported film was separately placed in a stainless-steel crossflow cell. The supported film was tested for helium permeance at ambient room temperature (˜24° C.) at 5 to 10 psig feed pressure at 200-mL/min (STP) and a gauge permeate pressure. Permeate gas flowrate was measured using an Agilent ADM flow meter, modelG6691A. The PTMSP supported film had a helium permeance of approximately 5800 GPU at pressures between 5 and 10 psig. The Teflon® AF 2400 supported film had a helium permeance of approximately 7900 GPU.

### Example 2

Gas-separation layer fabrication on a PTMSP gutter layer or Teflon® AF 2400 gutterlayer control. Aquivion® D72-25BS dispersion (25% w/w) in water (Solvay, Houston TX), having a 720-g/mole equivalent weight, was diluted to 1.5% with isopropanol and subsequently filtered through 1 μm glass microfiber to prepare a solution of the fluorinated ionomer. The solution of the fluorinated ionomer was then separately cast, using a vertical roll coater, onto the PTMSP film or the Teflon® AF 2400 film that were prepared in example 1. The isopropanol and water were evaporated at ambient room temperature under a nitrogen atmosphere to form the gas-separation layer. The gas-separation layer for each thin-film composite membrane was subsequently annealed at 120 to 130° C. for approximately 1 minute by infrared heating. An apparent laminar thickness for the gas-separation layer on the PTMSP gutter layer was gravimetrically estimated at 0.62 μm using the applied solution mass, concentration, membrane area, and Solvay's reported Aquivion® density of 2.07-g/mL. An apparent laminar thickness for the gas-separation layer on the Teflon® AF 2400 gutter layer control was similarly estimated at 0.69 μm.

### Example 3

Gas-separation layer fabrication directly on the porous-layer support. The fluorinated ionomer solution as prepared in example 2 was cast, using a vertical roll coater, directly onto a 100 cm×200 cm PVDF porous-layer support as described in example 1. The isopropanol and water were evaporated at ambient room temperature under a nitrogen atmosphere to form the gas-separation layer. The gas-separation layer on the thin-film composite membrane was subsequently annealed at 120 to 130° C. for approximately 1 minute by infrared heating. An apparent laminar thickness for the gas-separation layer was gravimetrically estimated at 0.67 μm using the applied solution mass, concentration, membrane area, and Solvay's reported Aquivion® density of 2.07-g/mL.

### Example 4

Activation of the gas-separation layer, thin-film composite membrane thickness from helium (He) permeance and beginning of life performance for mixed gas separation of propylene from propane. Circular samples (47-mm diameter) from each of the thin-film composite membranes prepared in examples 2 and 3 were separately activated by immersion in 0.15 M aqueous silver nitrate for 1 minute. Excess silver nitrate solution was gently blown off with dry air and the circular samples were separately configured in stainless-steel crossflow cells. The circular samples were first tested for helium permeance under dry conditions at ambient room temperature (˜24° C.) at 30 and 50 psig feed pressures at 200-mL/min (STP) and atmospheric pressure permeate. The permeate flowrate was measured using an Agilent ADM flow meter, modelG6691A. Helium (He) permeances were less than 25 GPU and an estimate for the thickness of the thin-film composite membranes from helium permeance was calculated by dividing a helium permeability of 22 Barrers for Aquivion® (20 Barrers for Nafion®) in the gas-separation layer by the measured helium permeance using the dry permeability disclosed by Baschetti et al. in “Gas permeation in perfluorosulfonated membranes: Influence of temperature and relative humidity” International Journal of Hydrogen Energy 38 (2013) 11973-11982.

The samples were subsequently tested for beginning of life performance for separation of a 50/50 feed mixture of propylene and propane. The 50/50 feed mixture at 200-mL/min (STP) was first passed through a water bubbler for humidification at ambient room temperature before entering the crossflow cell, also at ambient room temperature. A backflow pressure regulator at the retentate outlet maintained the feed pressure at 60-psig. The stage cut was less than 5% and the permeate flowrate (at atmospheric pressure) was measured using a soap-film flowmeter. The permeate composition was measured by gas chromatography. Table 1 summarizes the thickness of the thin-film composite membrane calculated from helium permeance and the beginning of life separation performance. At least three samples of each thin-film composite membrane were tested, and average (Avg) values and standard deviations (SDev) are shown. Membranes having a PTMSP or Teflon® AF 2400 gutter layer had at least 50% higher average propylene (C3H6) over propane (C3Hs) separation selectivity in addition to the expected increased permeance that was at least 75% higher.

TABLE 1

| | | C₃H₆ Permeance | | | |
|---|---|---|---|---|---|
| Polymer | Membrane | (GPU) | | C₃H₆/C₃H₈ Selectivity | |
| Material in the | He thickness | | Avg | | Avg |
| Gutter Layer | (μm) | | (SDev) | | (SDev) |
| PTMSP | 1.7 | 125 | 126 (9) | 46 | 43 (6) |
| | 1.5 | 137 | | 49 | |
| | 1.4 | 114 | | 37 | |
| | 1.6 | 126 | | 39 | |
| Teflon ® AF | 0.7 | 101 | 119 (26) | 15 | 61 (40) |
| 2400 control | 1.0 | 149 | | 89 | |
| | 1.3 | 106 | | 80 | |
| none | 1.5 | 66 | 64 (2) | 27 | 27 (1) |
| | 1.4 | 62 | | 26 | |
| | 1.4 | 65 | | 28 | |

### Example 5

PTMSN or PTCNSi2g gutter layer fabrication on a porous-layer support: A 5% (w/w) solution of poly(5-trimethylsilyl norbornene) (PTMSN) in toluene is diluted with heptane to 0.5% and filtered through 1 μm glass microfiber. A 0.5% (w/w) solution of PTCNSi2g is prepared in heptane and filtered through 1 μm glass microfiber. The solutions are then separately cast, using a vertical roll coater, on a 100 cm×200 cm porous-layer support comprising polyvinylidine fluoride (PVDF) ultra-filtration membrane, having a molecular weight cut-off of 100,000 Daltons, on a non-woven polyester backing (Synder, Filtration, Vacaville CA). The solvents are evaporated at ambient room temperature under a dry nitrogen atmosphere to form the gutter layers. An apparent laminar thickness for the PTMSN and PTCNSi2g gutter layers is gravimetrically estimated at between 0.75-μm and 0.85-μm using the applied solution mass, concentration, porous-layer support area, and PTMSN or PTCNSi2g densities of 0.88-g/mL and 0.85-g/mL, respectively. A 47-mm diameter circle is punched from each of the supported films and separately configured in a stainless-steel crossflow cell. The supported films are tested for helium permeance at ambient room temperature (˜24° C.) at 5 psig feed pressure at 200-mL/min (STP), and a gauge permeate pressure. Permeate gas flowrate is measured using an Agilent ADM flow meter, modelG6691A. The helium permeance of the PTMSN supported film is at least 7500 GPU and the PTCNSi2g supported film is at least 8300 GPU.

### Example 6

Gas-separation layer fabrication on a PTMSN or PTCNSi2g gutter layer and activation of the gas-separation layer Aquivion® D72-25BS dispersion (25% w/w) in water (Solvay, Houston TX), having a 720-g/mole equivalent weight, was diluted to 1.5% with isopropanol and subsequently filtered through 1 μm glass microfiber to prepare a fluorinated ionomer solution. The fluorinated ionomer solution is separately cast, using a roll coater, onto the PTMSN or PTCNSi2g films as prepared in example 5. The isopropanol and water are evaporated at ambient room temperature under a nitrogen atmosphere to form the gas-separation layer. The gas-separation layers on the thin-film composite membranes are subsequently annealed at 120 to 130° C. for approximately 1 minute by infrared heating. An apparent laminar thickness for the gas-separation layers is gravimetrically estimated at approximately 0.6 μm using the applied solution mass, concentration, PTMSN or PTCNSi2g supported film areas, and Solvay's reported Aquivion® density of 2.07-g/mL. Circular 47 mm diameter samples from each of the thin-film composite membranes having a PTMSN or PTCNSi2g gutter layer were separately activated by immersion in 0.15 M aqueous silver nitrate for 1 minute. Excess silver nitrate solution was gently blown off with dry air.

### Example 7

Tape adhesion test. Painter's masking tape (manufactured by 3M), which was % inch wide, was applied to the surface of additional circular membrane samples of thin-film composite membranes from examples 4 and 6 that were activated with silver nitrate as described therein. One end of the tape was near the center of the membrane circle and the other end extended past the edge. The tape was then peeled back from the edge to the center. The gas-separation layer remained attached to the gutter layer for the circular membrane sample having a gutter layer from PTMSP and remains attached to the respective gutter layers for the circular membrane samples having gutter layers from PTMSN and PTCNSi2g. The gas-separation layer peeled away and was adhered to the tape from the thin-film composite membrane of example 4 that had a gutter layer from Teflon® AF 2400.

### Example 8

Spiral-wound module fabrication and separation performance. A 30 cm×100 cm sheet of a thin-film composite membrane from example 2 having a gutter layer from either Teflon® AF 2400 or PTMSP was activated with silver nitrate for alkene separation as outlined in example 4. As generally outlined in the specification, a spiral-wound module comprising a single leaf was separately fabricated from each of the sheets. The spiral-wound modules had an active area of 1500 cm². The spiral-wound modules were separately configured in a pressure vessel and tested with nitrogen for permeance and potential leaks. The spiral wound-module having a PTMSP gutter layer had a nitrogen permeance less than 1-GPU. The spiral wound-module having a gutter layer from Teflon® AF 2400 had a nitrogen permeance of approximately 2-GPU. The pressure vessels containing the spiral-wound modules were separately configured in an apparatus designed for testing large-area modules for alkene/alkane permeance and separation selectivity at closer to commercial operation conditions. The spiral-wound modules were tested with a humidified 60/40 mixture of propylene and propane at a 145-psig feed pressure. The stage cut was 35% and the permeate pressure was 2-psig. The spiral wound-module having a gutter layer from Teflon® AF 2400 had a propylene permeance of 50 GPU and selectivity over propane of 5. The spiral wound-module having a PTMSP gutter layer had a propylene permeance of 105 GPU and selectivity over propane of 12.

### Example 9

Thin-film composite membrane having a gas-separation layer incorporating a Nafion® ionomer on a PTMSP gutter layer. Nafion® D2020 dispersion (20% w/w) in n-propanol/water, purchased from Ion Power (New Castle, DE) having a 1000-g/mole equivalent weight, was diluted to 1.5% with isopropanol and subsequently filtered through 1 μm glass microfiber to prepare a fluorinated ionomer solution. A 3″ diameter circle of the PTMSP supported film from example 1 was placed in a 3″ diameter ring holder and covered with the fluorinated ionomer solution. The ring holder was slightly tilted, and the excess solution was pipetted away. The remaining wet film was quickly weighed then dried in a horizontal position at ambient room temperature under a dry nitrogen atmosphere to form the gas-separation layer. The thin-film composite membrane was subsequently heat treated in a forced air oven at 120° C. for approximately 3 minutes while still in the ring holder. A laminar thickness for the gas-separation layer was gravimetrically estimated at 0.88 μm using the applied solution mass, concentration, PTMSP supported-film area, and Chemours' reported Nafion® density of 1.97-g/mL. The thin-film composite membrane was activated with 0.15M silver nitrate then configured in a stainless-steel crossflow cell for beginning of life performance for separation of propylene from propane as described in example 4. The membrane thickness from helium permeance was 0.6 μm, the propylene permeance was 90 GPU, and the selectivity over propane was 49. A second thin-film composite membrane was prepared in the same manner and tested for tape adhesion as outlined in example 7. The gas-separation layer could not be removed with the blue painter's tape and remained attached to the gutter layer.

### Example 10

Carbon dioxide (CO₂) permeance and mixed-gas selectivity over nitrogen. Circular membrane samples (47-mm diameter) of the thin-film composite membranes of examples 2 and 3 having a PTMSP gutter layer and no gutter layer, respectively, were separately configured in a stainless-steel crossflow cell and tested for C02 permeance and selectivity over nitrogen. C02 and nitrogen were fed from separate gas cylinders and mass flow controllers and then mixed. The gas mixture contained 40% C02 at 2 L/min (STP) and was passed through a water bubbler for humidification at ambient room temperature before entering the crossflow cell, also at ambient room temperature. A backflow pressure regulator at the retentate outlet maintained the feed pressure at 60 psig. The stage cuts were less than 2% and the permeate flow rate at atmospheric pressure was measured using an Agilent 1100 flowmeter. The C02 concentration in the permeate flow was measured using a Landtec 5000 biogas analyzer. The calculated C02 permeance for the thin-film composite membrane having a PTMSP gutter layer was 500 GPU and the selectivity over nitrogen was 40. The calculated CO₂ permeance for the thin-film composite membrane having no gutter layer was 220 GPU and the selectivity over nitrogen was 35.

### Example 11

Gas-separation layer fabrication from a fluorinated ionomer having silver sulfonate functionality. Aquivion® D72-25BS dispersion (25% w/w) in water (Solvay, Houston TX), having a 720-g/mole equivalent weight, was diluted to 2.5% with isopropanol and stirred overnight with 1 equivalent of silver carbonate to sulfonic acid functionality. The mixture was subsequently filtered through 1 μm glass microfiber to remove excess silver carbonate from the solution of the fluorinated ionomer having silver sulfonate functionality. The solution of the fluorinated ionomer was then cast, using a vertical roll coater, onto a PTMSP supported film that was prepared as described in example 1. The isopropanol and water were evaporated at ambient room temperature under a nitrogen atmosphere to form the gas-separation layer. An apparent laminar thickness for the gas-separation layer on the PTMSP gutter layer was gravimetrically estimated at 1.2 μm using an applied solution mass, concentration, PTMSP gutter layer/porous-layer support area, and Solvay's reported Aquivion® density of 2.07-g/mL. The gas-separation layer could not be removed from the gutter layer using blue painter's tape as described in example 7. A circular membrane sample (47 mm dia.) was tested as described in example 4 at 50° C. for beginning of life separation of propylene from propane. The propylene permeance was 110-GPU and the selectivity over propane was 41.

What is claimed is:

1. A thin-film composite membrane comprising:
a) a porous-layer support;
b) a gas-separation layer comprising a fluorinated ionomer; and
c) a gutter layer comprising a polymer material having a glass transition temperature greater than 100° C.; and
wherein the polymer material is selected from a substituted polyacetylene comprising a repeating unit structure (I), an addition-polymerized and substituted polynorbornene comprising a repeating unit structure (II), or an addition-polymerized and substituted polytricyclononene comprising a repeating unit structure (III): 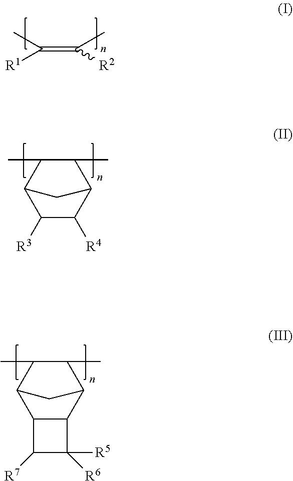
wherein n is a number that defines the degree of polymerization; R¹ comprises an alkyl or an aromatic group; R² comprises an aromatic group or a silyl group; R³ is H or comprises an alkyl group, a silyl group, or an alkoxy-silyl group; R⁴ comprises a silyl group, or an alkoxy-silyl group; R⁵ is H or comprises a silyl group or an alkoxy-silyl group; R⁶ comprises a silyl group or an alkoxy-silyl group; R⁷ is H, or if R⁵ is H, then R⁷ comprises a silyl group or an alkoxy-silyl group.

2. The thin-film composite membrane of claim 1, wherein the polymer material has an intrinsic permeability to carbon dioxide that is greater than 2800 Barrer (8.04×10⁻¹³ mol m/(m² s Pa)).

3. The thin-film composite membrane of claim 1, wherein the substituted polyacetylene is a silyl-substituted polyacetylene.

4. The thin-film composite membrane of claim 1, wherein the addition polymerized and substituted polynorbornene is an addition polymerized and silyl-substituted polynorbornene.

5. The thin-film composite membrane of claim 1, wherein the addition-polymerized and substituted polytricyclononene is an addition-polymerized and silyl-substituted polytricyclononene.

6. The thin-film composite membrane of claim 3, wherein the silyl-substituted polyacetylene is poly(1-trimethylsilyl propyne).

7. The thin-film composite membrane of claim 4, wherein the addition-polymerized and silyl-substituted polynorbornene is poly(5-trimethylsilyl norborn-2-ene).

8. The thin-film composite membrane of claim 5, wherein the addition-polymerized and silyl-substituted polytricyclononene is poly(3,3-bis(trimethylsilyl)tricyclonon-7-ene).

9. The thin-film composite membrane of claim 1, wherein the fluorinated ionomer comprises sulfonic acid or sulfonate functionality selected from silver sulfonate, ammonium sulfonate, alkyl-ammonium sulfonate, lithium sulfonate, or sodium sulfonate.

10. The thin-film composite membrane of claim 1, wherein the fluorinated ionomer comprises polymerized repeating units of tetrafluoroethylene and a perfluorovinyl ether monomer comprising a pendant sulfonic acid or sulfonate functionality.

11. The thin-film composite membrane of claim 1, wherein the porous-layer support comprises polyvinylidine fluoride, expanded polytetrafluoroethylene, polyacrylonitrile, polysulfone, or polyethersulfone.

12. The thin-film composite membrane of claim 1, wherein the gutter layer thickness is between 0.1 μm and 1 μm.

13. The thin-film composite membrane of claim 1, wherein gas-separation layer thickness is between 0.02 μm and 0.5 μm.

14. A spiral-would membrane module comprising the thin-film composite membrane of claim 1.

15. A process for separating carbon dioxide from a first gas mixture, the process comprising:
a) providing a thin-film composite membrane according to claim 1, having a feed side and a permeate side;
b) exposing the feed side to the first gas mixture that is flowing;
c) providing a driving force across the thin-film composite membrane; and
d) producing a second gas mixture on the permeate side that has a higher concentration of carbon dioxide than the concentration of carbon dioxide in the first gas mixture.

16. The process of claim 15, wherein the first gas mixture further comprises nitrogen or an alkane.

17. The process of claim 15, wherein the first gas mixture further comprises water vapor.

18. The process of claim 15, wherein providing a driving force comprises applying a vacuum to the permeate side.

19. A process for separating an alkene from a first gas mixture, the process comprising:
a) providing a thin-film composite membrane according to claim 1; the thing film-composite membrane comprising silver sulfonate functionality, a feed side, and a permeate side;
b) exposing the feed side to the first gas mixture that is flowing;
c) providing a driving force across the thin-film composite membrane; and
d) producing a second gas mixture on the permeate side that has a higher concentration of alkene than the concentration of alkene in the first gas mixture.

20. The process of claim 19, wherein the first gas mixture further comprises nitrogen or an alkane.

21. The process of claim 19, wherein the first gas mixture further comprises water vapor.
